(19) United States
(12) Patent Application Publication
(10) Pub. No.: US 2009/0147849 A1
(43) Pub. Date: Jun. 11, 2009

(54) INTRA FRAME ENCODING USING PROGRAMMABLE GRAPHICS HARDWARE

(75) Inventors: Oscar Chi Lim Au, Hong Kong (CN); Man Cheung Kung, Hong Kong (CN)

Correspondence Address: AMIN, TUROCY & CALVIN, LLP, 127 Public Square, 57th Floor, Key Tower, CLEVELAND, OH, 44114, US

(73) Assignee: THE HONG KONG UNIVERSITY OF SCIENCE AND TECHNOLOGY, Hong Kong (CN)

(21) Appl. No.: 12/234,721

(22) Filed: Sep. 22, 2008

Related U.S. Application Data
(60) Provisional application No. 61/012,102, filed on Dec. 7, 2007.

(51) Int. Cl. H04N 11/04

(52) U.S. Cl. 375/240.13; 375/E07.211

(57) ABSTRACT

GPU-based intra frame processing techniques are provided to selectively offload computation loading from a CPU to a GPU. By rearranging the 4×4 block encoding order, the process can benefit from a parallel processing mechanism available on the GPU. Block list size has an effect on speed and by using the optimal block list size for a selection, up to about two times speed improvement in intra frame processing can be achieved.

### CROSS-REFERENCE TO RELATED APPLICATIONS

This application claims priority to U.S. Provisional Application Ser. No. 61/012,102, filed on Dec. 7, 2007, entitled “INTRA FRAME ENCODING USING PROGRAMMABLE GRAPHICS HARDWARE”.

### TECHNICAL FIELD

The subject disclosure relates to efficient intra frame encoding using graphics hardware.

### BACKGROUND

H.264 is a commonly used and widely adopted international video coding or compression standard, also known as Advanced Video Coding (AVC) or Moving Pictures Experts Group (MPEG)-4, Part 10. H.264/AVC significantly improves compression efficiency compared to previous standards, such as H.263+ and MPEG-4. To achieve such a high coding efficiency, H.264 is equipped with a set of tools that enhance prediction of content at the cost of additional computational complexity. In H.264 macro-blocks are used wherein macro-block (MB) is a term generally used in the video compression art, which represents a block of 16 by 16 pixels. In the YUV color space model, each macro-block contains 4 8×8 luminance sub-blocks (or Y blocks), 1 U block, and 1 V block (4:2:0, wherein the U and V provide color information). It also could be represented by 4:2:2 or 4:4:4 YCbCr format (Cb and Cr are the blue and red Chrominance components).

Most video systems, such as H.261/3/4 and MPEG-1/2/4, exploit the spatial, temporal, and statistical redundancies in the source video. Some macro-blocks belong to more advanced macro-block types, such as skipped and non-skipped macro-blocks. In non-skipped macro-blocks, the encoder determines whether each of 8×8 luminance sub-blocks and 4×4 chrominance sub-block of a macro-block is to be encoded, giving the different number of encoded sub-blocks at each macro-block encoding times. It has been found that the correlation of bits between consecutive frames is high. Since the level of redundancy changes from frame to frame, the number of bits per frame is variable, even if the same quantization parameters are used for all frames. Therefore, a buffer is typically employed to smooth out the variable video output rate and provide a constant video output rate. Rate control is used to prevent the buffer from over-flowing (resulting in frame skipping) or/and under-flowing (resulting in low channel utilization) in order to achieve good video quality. For real-time video communication such as video conferencing, proper rate control is more challenging as the rate control is employed to satisfy the low-delay constraints, especially in low bit rate channels.

Accordingly, it would be desirable to provide faster intra frame processing during encoding of video data. The above-described deficiencies of current designs for video encoding are merely intended to provide an overview of some of the problems of today's designs, and are not intended to be exhaustive. Other problems with the state of the art and corresponding benefits of the invention may become further apparent upon review of the following description of various non-limiting embodiments.

### SUMMARY

Video data processing optimizations are provided for video encoding and outputting processes that efficiently encode and output data. Herein described are graphics processing unit (GPU)-based intra frame processing implementations to offload the computation loading from a central processing unit (CPU) to a GPU. By rearranging the 4×4 block encoding order, the process can favor from the parallel mechanism on the GPU. Block list size has an effect on speed and by using the optimal block list size for a selection, up to thirty times speed improvement can be achieved using the techniques described herein over conventional computation that does not benefit from the parallel computation.

In one exemplary non-limiting embodiment, a method for dividing an image frame into blocks is provided, including dividing the frame into diagonal N×N block lists, e.g., with a GPU. An exemplary non-limiting method includes outputting a first set of data by outputting data by embedding the data into a decimal place by division, and outputting data by embedding the data into an integer place by multiplication. The method can further include outputting a second set of data by outputting the second set of data without performing multiplication.

A simplified summary is provided herein to help enable a basic or general understanding of various aspects of exemplary, non-limiting embodiments that follow in the more detailed description and the accompanying drawings. This summary is not intended, however, as an extensive or exhaustive overview. The sole purpose of this summary is to present some concepts related to the various exemplary non-limiting embodiments of the innovation in a simplified form as a prelude to the more detailed description that follows.

### BRIEF DESCRIPTION OF THE DRAWINGS

The herein described optimizations for video encoding processes in accordance with the innovation are further described with reference to the accompanying drawings in which:

FIG. 1 shows a high-level diagram of modern graphics pipeline in accordance with an aspect of the innovation;

FIG. 2 illustrates 4×4 block intra prediction in accordance with an aspect of the innovation;

FIG. 3 is a high-level block diagram illustrating the MB coding is done in raster scan order in accordance with an aspect of the innovation;

FIG. 4 is a high-level block diagram of GPU-based Intra Frame Processing in accordance with an aspect of the innovation;

FIG. 5 shows the original encoding order of 16 4×4 blocks within one MB in accordance with an aspect of the innovation;

FIG. 6 shows the division of a 4×4 block list, the 4×4 blocks with the same number belong to the same block list and the number also represent block list encoding order in accordance with an aspect of the innovation;

FIG. 7 illustrates a method of data packing in accordance with an aspect of the innovation;

FIG. 8 illustrates the execution time for different sizes of block list in accordance with an aspect of the innovation;

FIG. 9 shows the performance of CPU or GPU selection with using Sₒ as the threshold;

FIG. 10 is a flow diagram illustrating an exemplary intra frame encoding process in accordance with one or more embodiments set forth herein;

FIG. 11 is a flow diagram illustrating an exemplary process for parallelizing one or more parts of encoding video in accordance with one or more embodiments set forth herein;

FIG. 12 is a block diagram representing an exemplary non-limiting computing system or operating environment in which the present innovation may be implemented; and

FIG. 13 illustrates an overview of a network environment suitable for service by embodiments of the innovation.

### DETAILED DESCRIPTION

### Overview

As an overview, with the development of the Internet and wireless networks, multimedia information, especially video content, has become increasingly popular (e.g., www.youtube.com). However, since the size of uncompressed video is usually quite large, it is impractical to transmit videos without compression without extraordinary bandwidth.

H.264 is an international coding standard developed by Joint Video Team (JVT) of ISO/IEC MPEG and ITU-T VCEG: Draft ITU-T recommendation and final draft international standard of joint video specification (ITU-T Rec. H.264/ISO/IEC 14 496-10 AVC). (2003) JVT-G050. The JVT consists of experts from the members in ITU-T's video coding experts group (VCEG) and ISO/IECs moving picture experts group (MPEG). The standard contains a number of new features to achieve video compression in a more effective way, e.g. multiple reference frames, sub-pixel motion estimation and a variety of intra mode processing techniques. With such advanced intra mode decisions, the rate distortion performance of intra frame encoding is greatly improved. However, the coding complexity increases at the same time. To reduce the computation complexity, conventional attempts at fast intra prediction have improved speed at the tradeoff of a reduction in or loss of peak signal to noise ratio (PSNR).

On the other hand, over the past few years, graphics hardware technology has grown at an unprecedented rate. The multi-billion dollar video game market has driven innovation and evolved the specialized nature of graphics hardware to use additional transistors for computation instead of cache. Nowadays, the graphics hardware is not only a specialized hardware for accelerating three-dimensional graphics processing and rendering, but also a co-processor, which equips a Graphics Processing Unit (GPU), to process data stream with user developed programs. According to the Moore's Law, the performance of CPUs has improved and is improving at an annual growth rate of approximately 1.4×. However, the annual growth rate of the performance of GPUs is currently 1.7× (pixel/sec) to 2.3× (vertices/sec), which is much faster than that of CPUs, thereby significantly outperforming Moore's law. GPUs grow with significant improvement on the quality of computation and programmability, providing both a powerful data parallel processing mechanism and more flexibility for general-purpose computing. In this regard, some conventional applications have proposed use of the GPU for both graphics and non-graphics applications to take advantage of the performance gains.

For instance, GPU-based decoding of video and GPU-based motion estimation have been proposed. However, there are no known attempts to accelerate intra frame encoding. Accordingly, in various non-limiting embodiments, efficient intra frame encoding is enabled that not only performs intra block prediction, but also generates the reconstructed blocks by rearranging the encoding order of 4×4 block on the GPU without losing any coding efficiency.

As an overview of what follows, next a representative programmable graphics pipeline is described and then, intra block encoding in H.264/AVC is discussed. Following the discussion of intra block encoding are the details of an exemplary non-limiting GPU-based implementation. Next, the performance of the herein described method is evaluated along with some conclusions generally based on the performance evaluation. Lastly, a general network environment and computing device that may take advantage of the GPU-based intra frame encoding as described herein is set forth for general non-limiting context.

### Programmable Graphics Pipelines

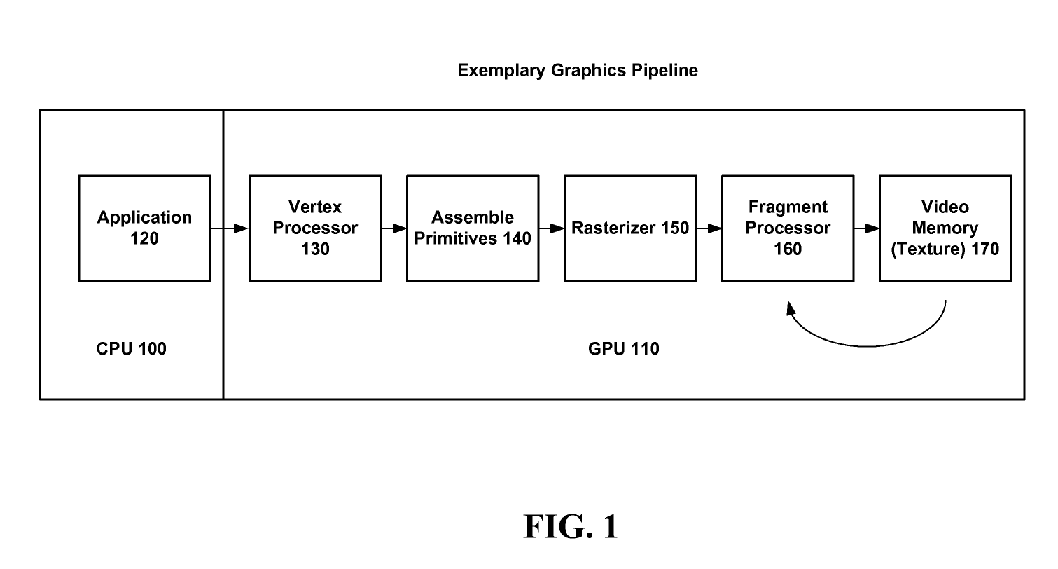

FIG. 1 shows a high-level diagram of a representative graphics pipeline. The typical use of graphics hardware is to process 3D data. The applications 120 use an API (application programming interface, for example OpenGL or Direct3D) to send the graphics geometry description as a stream of vertices from the CPU 100 to the GPU 110. These vertices are transformed to their final screen location by the vertex processor 130 that also assigns each vertex a color based on the scene lighting, and primitives are assembled 140. The rasterizer 150 converts geometry presentation (vertex) to image presentation (fragment). And it interpolates per-vertex quantities across pixels. Then the fragment processor 160, which is multiple in parallel, will compute the final color for each pixel and store back into the frame buffer 170. The user can implement customized operations by writing program called shaders on both vertex processor 130 and fragment processor 160 for per-vertex and per-fragment computing, respectively. In this regard, vertex processor 130 and fragment processor 160 are fully programmable and perform Single Instruction, Multiple Data (SIMD) like operations on a vector with 4 components.

In general purpose GPU (GPGPU) computation, the GPU is a stream processor that provides independent parallel processing, executing a number of kernels on data streams. The kernel is like a function applied on each data element of the stream. For the herein described intra block processing, the kernel is used for 4×4 block prediction and intra mode selection, image reconstruction processes including forward Integer Cosine Transform (ICT), quantization, inverse ICT (ICT⁻¹), De-Quantization (DeQ), and inverse prediction. Textures are used to store the original frame and the previous reconstructed neighbors block information, with further details given below.

### Intra Prediction in H.264/AVC

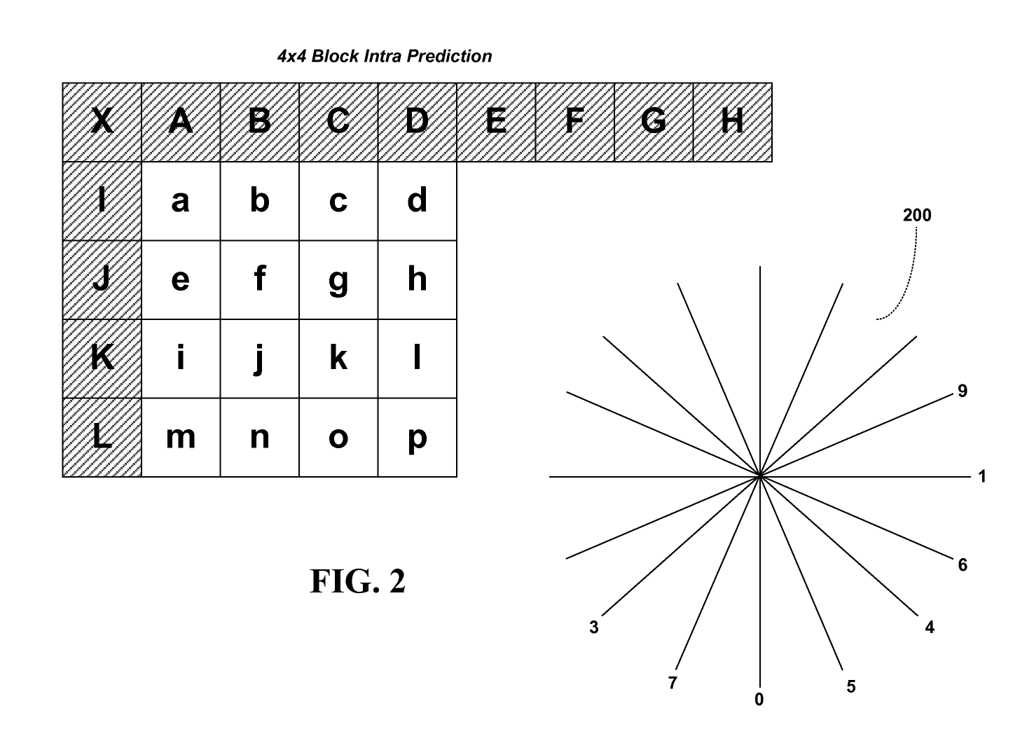

FIG. 2 illustrates 4×4 block intra prediction where symbols A to D denote 4 up 4×4 blocks, E denotes the up-right 4×4 block, F to H denote right 4×4 blocks, I to L the left 4×4 blocks and X denotes the up-left 4×4 block. The small blocks a to p represent the 4×4 blocks inside MB. In 4×4 block prediction, each 4×4 block is predicted from the spatially neighboring sample (see diagram 200) where symbols a to p are the current block pixels and symbols A to L and X are the neighbors block pixels to generate the prediction block. There are 9 prediction modes: one DC prediction mode and 8 directional prediction modes as seen in diagram 200 of FIG. 2.

In the mode decision part, the cost function composes of the sum of absolute difference (SAD) and Mode Cost, presenting a rate-constrained optimization problem and the best mode is selected that minimizes the Lagrangian cost function. The Mode Cost is a function of 4×4 block prediction mode m, Most Probable Mode (MPM) and the Lagrangian multiplier λ imposes rate constraint of coding mode information that is QP (quantization parameter) dependent. The cost function is shown in the following equations, where C is the original 4×4 block, Pₘ is the predict block with corresponding mode m and MPM denote the Most Probable Mode which is computed from the Intra mode of left and upper 4×4 block.

$$\begin{matrix}COST ( m , λ , MPM ) = S A D ( C , {P}_{m} ) + Mode\_COST ( m , λ , MPM ) \\ S A D ( C , P ( m ) ) = {\sum }_{y = 1}^{4} {\sum }_{x = 1}^{4} \vert C \vert y , x \vert - {P}_{m} \vert y , z \vert \vert \\ ModeCOST ( m , λ , MPM ) = ( m != MPM ) \times λ\end{matrix}$$

Since the intra prediction requires the previous coded neighbors block information, reconstructed pixels for building predict block and block modes for computing MPM take into account the dependency among adjacent blocks.

### CPU Working Flow for Intra Frame Processing

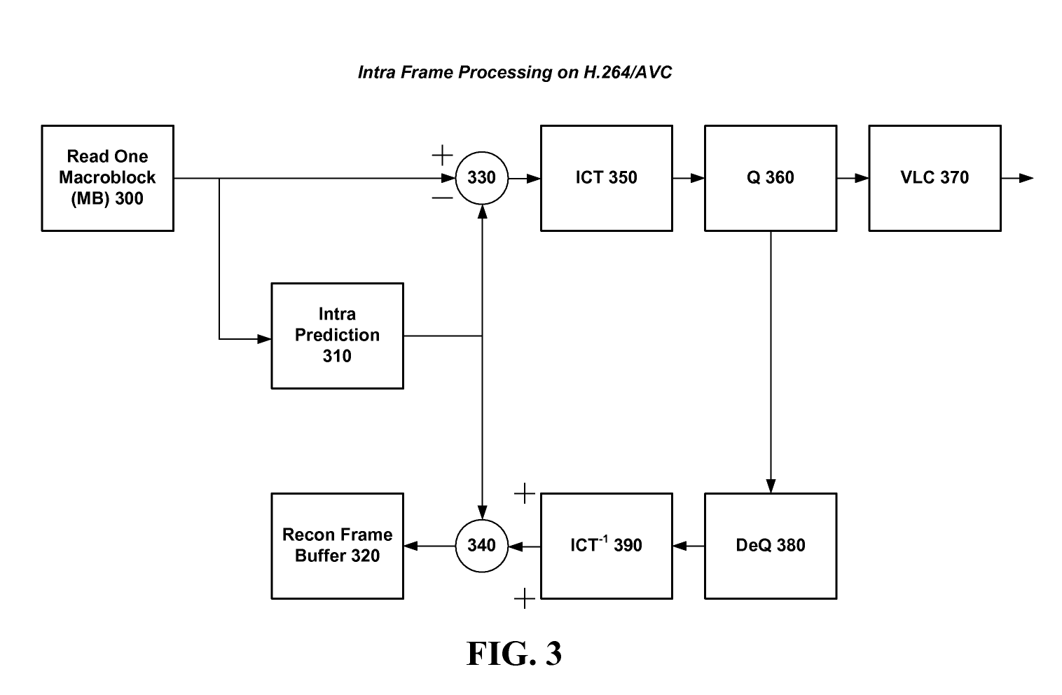

In reference software used in one embodiment, the MB coding is performed in raster scan order. The high-level block diagram is shown in FIG. 3 where Q stands for quantizer, DeQ for dequantizer, and VLC for variable length coder. A macroblock is read at 300 and then intra prediction 310 is performed and process 330 and 340 are carried out as indicated in the flow diagram. From 330, ICT 350, Q 360, VLC 370 are performed next, and DeQ380 and ICT⁻¹ 390 are also performed afterwards. The recon frame buffer 320 stores the result of the reconstructed data.

In this regard, the prediction block uses the previous coded neighbors MB and thus the processing of the next MB must wait until the processing of the current MB finishes. A high dependency is thus introduced between MBs leading to weak data parallelism due to the MB coding order. In consideration of this deficiency, below-described is a modified MB and a 4×4 block coding order to maximize the throughput of data parallel processing on a GPU.

### GPU-Based Intra Frame Processing

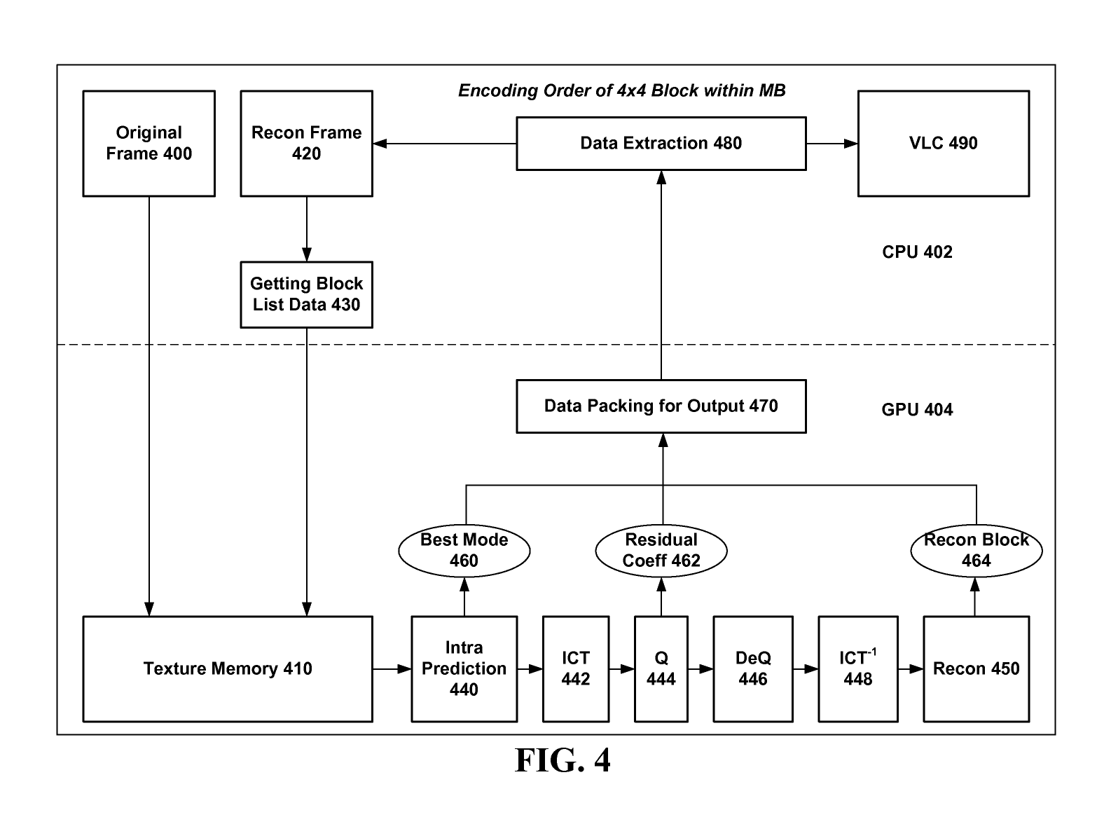

In one embodiment, GPU-based intra frame processing is enabled that performs 4×4 intra block prediction and generates the reconstruction block as the predict information for future blocks, thus effectively re-using information in an efficient manner. FIG. 4 shows a high-level block diagram of the GPU-based intra frame processing described herein in one embodiment, and additional details are discussed in the following subsections.

FIG. 4 generally illustrates the encoding order for a 4×4 block within a MB. Original frame 400 and reconstructed frame 420, and associated block list data 430 for efficient parallelization are transmitted by the CPU 402 to texture memory 410 of the GPU 404 for further processing. The data undergoes intra prediction 440, ICT 442, quantization 444, dequantization 446, inverse ICT 448 and reconstruction 450 in determining a best mode 460 from intra prediction 440, a set of residual coefficients 462 from quantization 444 and a reconstructed block 464 from reconstruction 450. Best mode 460, residual coefficients 462 and the reconstructed block 464 are prepared via data packing for output 470 from the GPU 404 back to the CPU 402, where the data is unpacked by data extraction 480 by the CPU 402. The reconstructed frame is output and ready for the next frame 400 and sent to VLC 490 to regulate the output for rendering, transmission, etc.

### Data Representation in Graphics Hardware

For the input data, current original 4×4 block and previous coded neighbors block information (pixel values and 4×4 intra prediction modes) are both used as input and also the current block availability. In this regard, as shown in FIG. 4, these can be represented as texture objects and stored in texture memory, though it is noted the bandwidth for memory access from CPU to GPU can be expensive.

As an exemplary non-limiting implementation, GL_RGBA can be used as the input data type, which is an OpenGL vector containing of 4 float data (red, green, blue, and alpha (RGBA)). The current original frame is loaded into the texture memory once, and the rest of the data is packed into one buffer and loaded into the texture memory for each process.

### Data-Level Parallelism

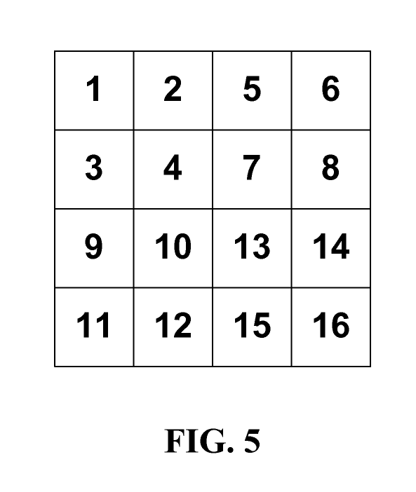

Above, it was noted that a dependency exists among adjacent blocks in connection with intra frame encoding. In this regard, FIG. 5 shows the original encoding order of 16 4×4 blocks within one MB. Symbols A to D denote 4 up 4×4 blocks, E denotes the up-right 4×4 block, F to I denote 4 left 4×4 blocks and X denotes the up-left 4×4 block. The small blocks represent the 4×4 blocks inside MB and the number in the block represents that block's place in the encoding order. While it has been proposed to rearrange the 4×4 block coding order to provide parallel processing between 4×4 blocks, thus far, such parallel processing has been limited to application within the same MB. Accordingly, as provided in various embodiments herein, given the large number of stream processors inside GPU, the parallel process can not only be applied to 4×4 blocks within same MB, but also the 4×4 blocks within same frame.

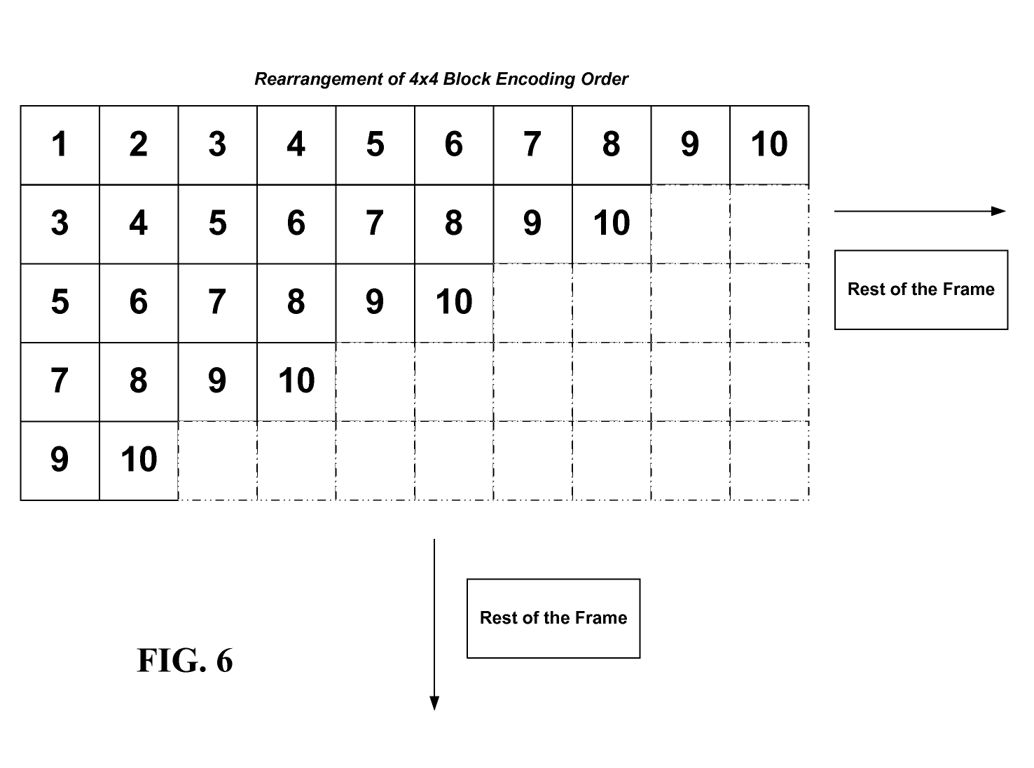

In this regard, herein described are techniques to divide the frame into a plurality of diagonal 4×4 block lists. FIG. 6 shows exemplary division of a 4×4 block list according to this technique, the 4×4 blocks with the same number belong to the same block list and the number also represents the block list encoding order. The lists are diagonal because the 9s are diagonal as well as the other numbers. Here each row is two off from the row above but the offset could be one or three, or another number. Since the offset remains fixed, the diagonalization property of the numbering stays true. Each row represents a parallel processing path or channel.

Accordingly, FIG. 6 illustrates an example of a plurality of N×N block lists encoded diagonally with respect to a plurality of parallel processing channels, and, more particularly, a plurality of N×N block lists encoded diagonally with respect to a plurality of parallel processing channels with an offset of two. Each square or block 1, 8, 9, etc. represents a 4×4 block, and each row represents a list (an N×N block list) and the plurality of lists form a plurality of N×N block lists. The lists are diagonal because the offset causes each specific number (except for one) to be on a diagonal. For each 4×4 block in the block list, per the CPU-GPU loop of FIG. 4, the necessary neighbors data is available after the previous block list process finished and they are independent to one another. The encoder processes the 4×4 diagonal block list from top-left to bottom-right. In this regard, thanks to the parallelism of GPU, the encoding of all of the 4×4 blocks can thus be done at the same time. This method solves the dependency problem and provides a high degree of parallelism.

### Output Data Packing

Existing graphics hardware can currently support a maximum of 1024 bits as output and the consumer-level graphics hardware usually supports 512 bits as output. The output has 4 vectors with 4 components and uses 32 bits float as the data type for each component. For the output data, there is one 4×4 reconstruction block, one 4×4 residual coefficients block and a current block mode. The GPU provides in total 16 floating number (32 bits for each) to store the output data. Inside the kernel, bit shifting operations are not supported. Therefore, one cannot directly embed the data into high 16 bits. As a floating point number can represent as one integer number plus one decimal number less than one. One can embed the output data into both integer and decimal place by multiplying and dividing the data as illustrated in one exemplary non-limiting embodiment described below. For the 4×4 reconstruction block, which is all positive and within the range from 0 to 255, it is more suitable to embed into the decimal place.

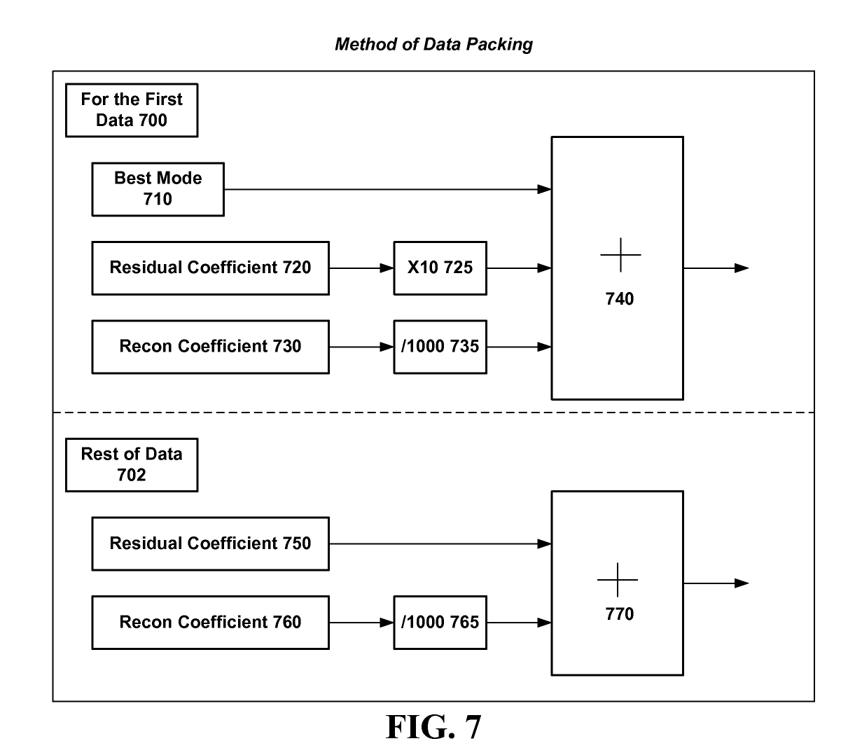

FIG. 7 illustrates an exemplary data packing process. Where for the first data output 700, the residual coefficient 720 is multiplied 725 and placed in the integer place in storage 740 while the reconstruction coefficient 730 is divided 735 and placed in the decimal place in storage 740. The multiplication is illustrated as being by 10 and the division by 1000, but these are merely examples, and other suitable numbers can be employed. For a non-limiting example, the multiplication can be by a number between 5 and 15. Alternatively, the multiplication can be by a number between 2 and 50. The division can also be by a number between 10 and 10000 inclusively. Subsequent data 702 outputs the residual coefficient 750 without multiplication or modification while the reconstruction coefficient 760 is divided 765 and placed in the decimal place in storage 770.

### Performance

For exemplary non-limiting observation of performance of the above-described techniques, some simulations were run on a PC equipped with a graphics card with 96 stream processors (1200 Mhz for each) and 4 3.2 GHz processors with 1 GB DDR2 memory. The simulation was designed to observe the impact on limited download bandwidth from GPU to CPU and the speed up ratio compared with a conventional CPU only implementation.

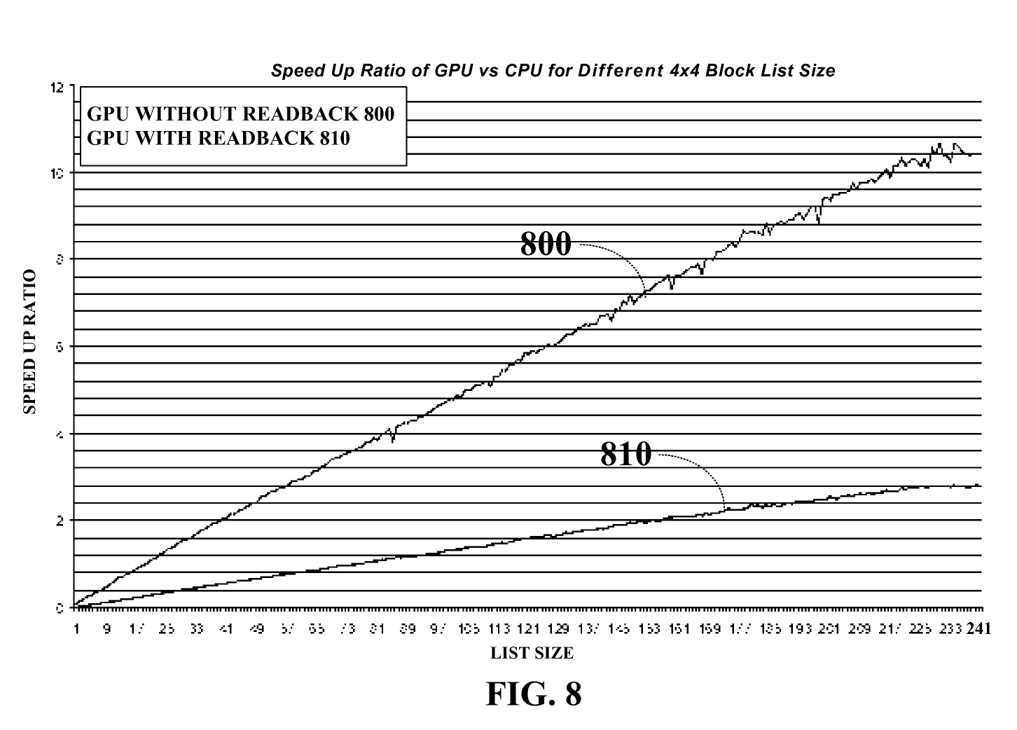

Performance of execution time began at the intra prediction and ended at the generating of the reconstructed image. In order to show how download bandwidth limit from GPU to CPU impacted the performance, the performance was observed with and without readback data from GPU to CPU. With respect to execution time for different sizes of block lists, FIG. 8 shows the results. As might be expected, for shorter block lists, fewer blocks can be processed in parallel, and thus, the overhead of data I/O becomes significant. But for longer block lists, the gain from processing the list with a GPU is significant due to the predominating benefit of parallelization mechanism, which diminishes the effect of setup overhead of the GPU on overall processing time. In brief, the longer the block list, the more speed up that results. The optimal block list size Sₒ can be obtained for different testing conditions. For instance, the speed up ratio is greater than 1 when block list size is longer then Sₒ.

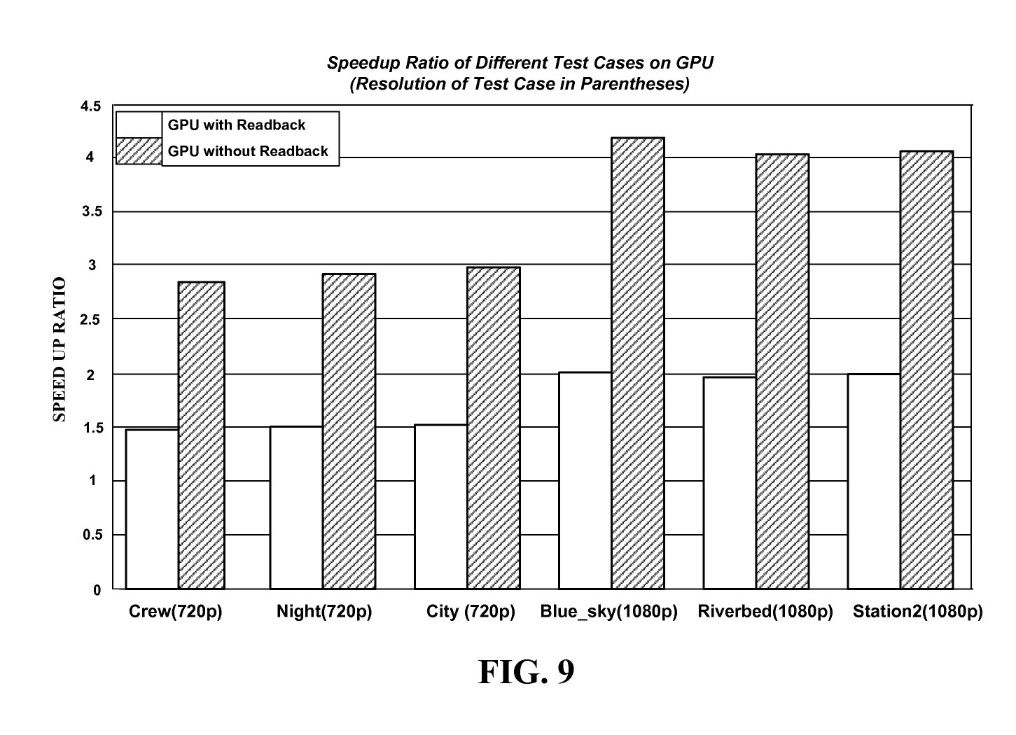

Finally, as an optimization, one can adjust the selection of processing block lists by using the CPU or GPU according to a threshold determination. If the sizes of block lists are smaller than Sₒ, the processing can run on the CPU, otherwise on the GPU. FIG. 9 shows the performance of CPU or GPU selection using Sₒ as the threshold for different image sequences named crew, night, city, blue_sky, riverbed and station2, respectively at different high definition resolutions of 720 p or 1080 p.

From the results, the speed up ratio of results from applying readback to results without readback is about 2, or twice the speed. Needless to say, 2 times is a significant improvement in processing speed, accomplishing twice as much for a given time than conventional methods. FIG. 9 thus illustrates that the readback of data from the GPU to CPU is the main bottleneck, i.e., the overhead of readback data from the GPU to the CPU is the domain of the process.

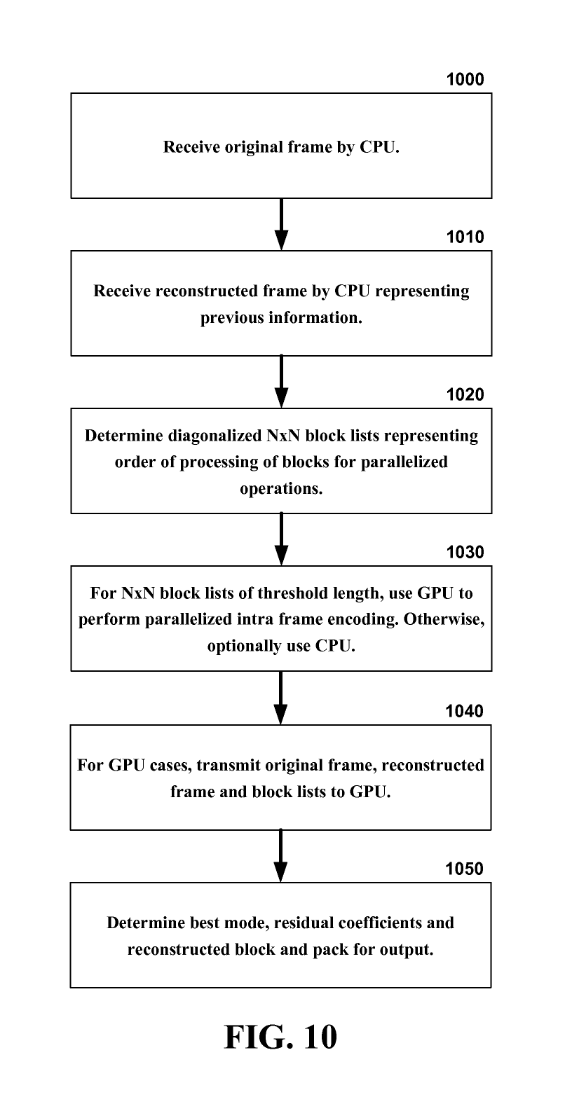

FIG. 10 is a flow diagram illustrating an exemplary intra frame encoding process in accordance with one or more embodiments set forth herein. At 1000, an original frame is received by the CPU for encoding. At 1010, a reconstructed frame is available at the CPU representing previous information for use in encoding. At 1020, a diagonalized set of N×N block lists are determined representing order of processing of blocks for parallelized operations. At 1030, for N×N block lists of threshold length, the GPU is used to perform parallelized intra frame encoding. Otherwise, optionally the CPU is used since the benefit of the GPU may not be realized for short block lists. For GPU cases, at 1040, the original frame, reconstructed frame and block lists are transmitted to the GPU where at 1050, the best mode, residual coefficients and reconstructed block are determined, and the data is packed for output back to the CPU.

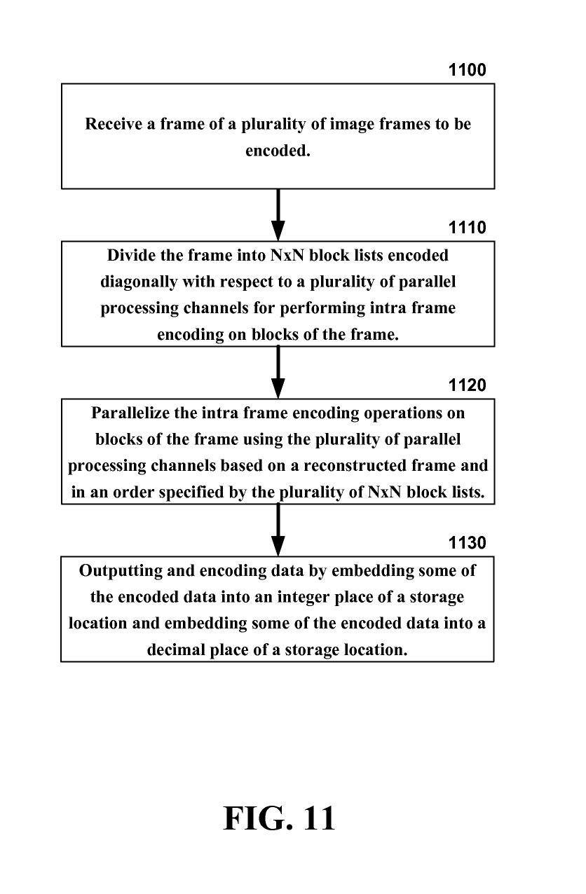

FIG. 11 is a flow diagram illustrating an exemplary process for parallelizing one or more parts of video encoding processes in accordance with one or more embodiments. At 1100, a frame of sequence of image frames to be encoded is received. At 1110, the frame is divided into N×N block lists encoded diagonally with respect to a parallel processing channels for performing intra frame encoding on blocks of the frame. At 1120, the intra frame encoding operations on blocks of the frame are parallelized using the parallel processing channels based on a reconstructed frame and in an order specified by the plurality of N×N block lists. At 1130, data output includes embedding of some of the data into an integer place of a storage location and embedding some of the data into a decimal place of the storage location.

### Observations

Herein, various GPU-based intra frame processing implementations are set forth to offload the computation loading from CPU to GPU. By rearranging the 4×4 block encoding order, the process can benefit from the parallel mechanism on GPU. By using the optimal block list size for the selection, up to thirty times speed-up can be achieved. However, the performance improvement is limited by the download bandwidth limitation. Since output data for one 16×16 MB exceeds the current limit of output data size, to support 16×16 intra prediction, one could compress the data prior to the output process.

### Exemplary Computer Networks and Environments

One of ordinary skill in the art can appreciate that the innovation can be implemented in connection with any computer or other client or server device, which can be deployed as part of a computer network, or in a distributed computing environment, connected to any kind of data store. In this regard, the present innovation pertains to any computer system or environment having any number of memory or storage units, and any number of applications and processes occurring across any number of storage units or volumes, which may be used in connection with optimization algorithms and processes performed in accordance with the present innovation. The present innovation may apply to an environment with server computers and client computers deployed in a network environment or a distributed computing environment, having remote or local storage. The present innovation may also be applied to standalone computing devices, having programming language functionality, interpretation and execution capabilities for generating, receiving and transmitting information in connection with remote or local services and processes.

Distributed computing provides sharing of computer resources and services by exchange between computing devices and systems. These resources and services include the exchange of information, cache storage, and disk storage for objects, such as files. Distributed computing takes advantage of network connectivity, allowing clients to leverage their collective power to benefit the entire enterprise. In this regard, a variety of devices may have applications, objects, or resources that may implicate the optimization algorithms and processes of the innovation.

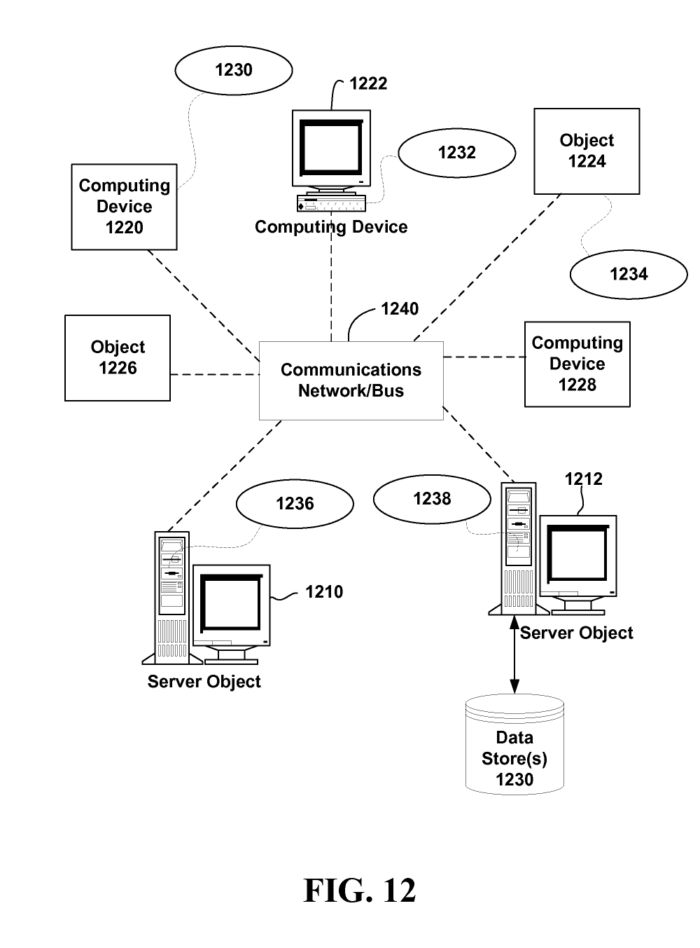

FIG. 12 provides a schematic diagram of an exemplary networked or distributed computing environment. The distributed computing environment comprises computing objects 1210a, 1210b, etc. and computing objects or devices 1220a, 1220b, 1220c, 1220d, 1220e, etc. These objects may comprise programs, methods, data stores, programmable logic, etc. The objects may comprise portions of the same or different devices such as PDAs, audio/video devices, MP3 players, personal computers, etc. Each object can communicate with another object by way of the communications network 1240. This network may itself comprise other computing objects and computing devices that provide services to the system of FIG. 12, and may itself represent multiple interconnected networks. In accordance with an aspect of the innovation, each object 1210a, 1210b, etc. or 1220a, 1220b, 1220c, 1220d, 1220e, etc. may contain an application that might make use of an API, or other object, software, firmware and/or hardware, suitable for use with the design framework in accordance with the innovation.

It can also be appreciated that an object, such as 1220c, may be hosted on another computing device 1210a, 1210b, etc. or 1220a, 1220b, 1220c, 1220d, 1220e, etc. Thus, although the physical environment depicted may show the connected devices as computers, such illustration is merely exemplary and the physical environment may alternatively be depicted or described comprising various digital devices such as PDAs, televisions, MP3 players, etc., any of which may employ a variety of wired and wireless services, software objects such as interfaces, COM objects, and the like.

There are a variety of systems, components, and network configurations that support distributed computing environments. For example, computing systems may be connected together by wired or wireless systems, by local networks or widely distributed networks. Currently, many of the networks are coupled to the Internet, which provides an infrastructure for widely distributed computing and encompasses many different networks. Any of the infrastructures may be used for exemplary communications made incident to optimization algorithms and processes according to the present innovation.

In home networking environments, there are at least four disparate network transport media that may each support a unique protocol, such as Power line, data (both wireless and wired), voice (e.g., telephone) and entertainment media. Most home control devices such as light switches and appliances may use power lines for connectivity. Data Services may enter the home as broadband (e.g., either DSL or Cable modem) and are accessible within the home using either wireless (e.g., HomeRF or 802.11A/B/G) or wired (e.g., Home PNA, Cat 5, Ethernet, even power line) connectivity. Voice traffic may enter the home either as wired (e.g., Cat 3) or wireless (e.g., cell phones) and may be distributed within the home using Cat 3 wiring. Entertainment media, or other graphical data, may enter the home either through satellite or cable and is typically distributed in the home using coaxial cable. IEEE 1394 and DVI are also digital interconnects for clusters of media devices. All of these network environments and others that may emerge, or already have emerged, as protocol standards may be interconnected to form a network, such as an intranet, that may be connected to the outside world by way of a wide area network, such as the Internet. In short, a variety of disparate sources exist for the storage and transmission of data, and consequently, any of the computing devices of the present innovation may share and communicate data in any existing manner, and no one way described in the embodiments herein is intended to be limiting.

The Internet commonly refers to the collection of networks and gateways that utilize the Transmission Control Protocol/Internet Protocol (TCP/IP) suite of protocols, which are well known in the art of computer networking. The Internet can be described as a system of geographically distributed remote computer networks interconnected by computers executing networking protocols that allow users to interact and share information over network(s). Because of such wide-spread information sharing, remote networks such as the Internet have thus far generally evolved into an open system with which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the illustration of FIG. 12, as an example, computers 1220a, 1220b, 1220c, 1220d, 1220e, etc. can be thought of as clients and computers 1210a, 1210b, etc. can be thought of as servers where servers 1210a, 1210b, etc. maintain the data that is then replicated to client computers 1220a, 1220b, 1220c, 1220d, 1220e, etc., although any computer can be considered a client, a server, or both, depending on the circumstances. Any of these computing devices may be processing data or requesting services or tasks that may implicate the optimization algorithms and processes in accordance with the innovation.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the optimization algorithms and processes of the innovation may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

Thus, FIG. 12 illustrates an exemplary networked or distributed environment, with server(s) in communication with client computer (s) via a network/bus, in which the present innovation may be employed. In more detail, a number of servers 1210a, 1210b, etc. are interconnected via a communications network/bus 1240, which may be a LAN, WAN, intranet, GSM network, the Internet, etc., with a number of client or remote computing devices 1220a, 1220b, 1220c, 1220d, 1220e, etc., such as a portable computer, handheld computer, thin client, networked appliance, or other device, such as a VCR, TV, oven, light, heater and the like in accordance with the present innovation. It is thus contemplated that the present innovation may apply to any computing device in connection with which it is desirable to communicate data over a network.

In a network environment in which the communications network/bus 1240 is the Internet, for example, the servers 1210a, 1210b, etc. can be Web servers with which the clients 1220a, 1220b, 1220c, 1220d, 1220e, etc. communicate via any of a number of known protocols such as HTTP. Servers 1210a, 1210b, etc. may also serve as clients 1220a, 1220b, 1220c, 1220d, 1220e, etc., as may be characteristic of a distributed computing environment.

As mentioned, communications may be wired or wireless, or a combination, where appropriate. Client devices 1220a, 1220b, 1220c, 1220d, 1220e, etc. may or may not communicate via communications network/bus 14, and may have independent communications associated therewith. For example, in the case of a TV or VCR, there may or may not be a networked aspect to the control thereof. Each client computer 1220a, 1220b, 1220c, 1220d, 1220e, etc. and server computer 1210a, 1210b, etc. may be equipped with various application program modules or objects 1235a, 1235b, 1235c, etc. and with connections or access to various types of storage elements or objects, across which files or data streams may be stored or to which portion(s) of files or data streams may be downloaded, transmitted or migrated. Any one or more of computers 1210a, 1210b, 1220a, 1220b, 1220c, 1220d, 1220e, etc. may be responsible for the maintenance and updating of a database 1230 or other storage element, such as a database or memory 1230 for storing data processed or saved according to the innovation. Thus, the present innovation can be utilized in a computer network environment having client computers 1220a, 1220b, 1220c, 1220d, 1220e, etc. that can access and interact with a computer network/bus 1240 and server computers 1210a, 1210b, etc. that may interact with client computers 1220a, 1220b, 1220c, 1220d, 1220e, etc. and other like devices, and databases 1230.

### Exemplary Computing Device

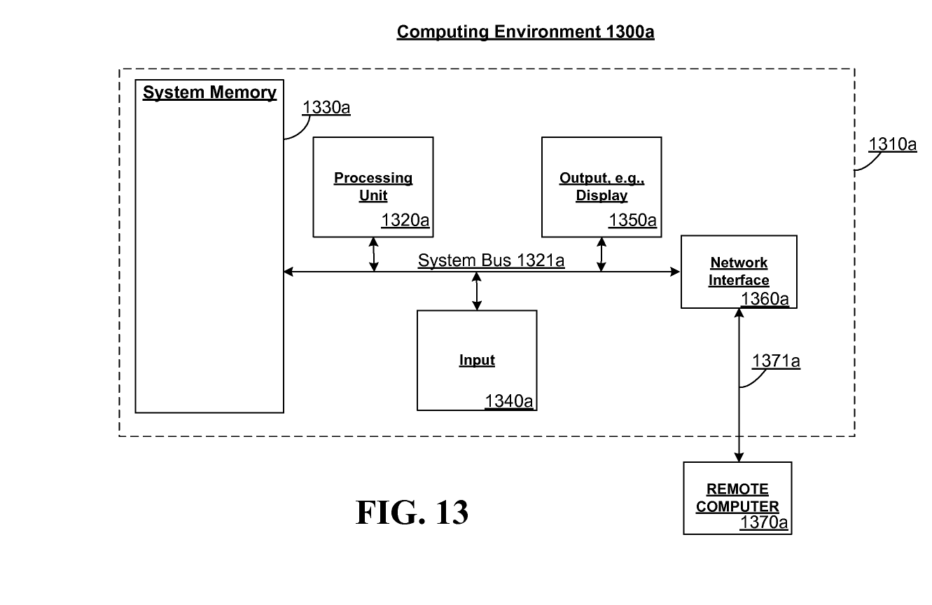

As mentioned, the innovation applies to any device wherein it may be desirable to communicate data, e.g., to a mobile device. It should be understood, therefore, that handheld, portable and other computing devices and computing objects of all kinds are contemplated for use in connection with the present innovation, i.e., anywhere that a device may communicate data or otherwise receive, process or store data. Accordingly, the below general purpose remote computer described below in FIG. 13 is but one example, and the present innovation may be implemented with any client having network/bus interoperability and interaction. Thus, the present innovation may be implemented in an environment of networked hosted services in which very little or minimal client resources are implicated, e.g., a networked environment in which the client device serves merely as an interface to the network/bus, such as an object placed in an appliance.

Although not required, the innovation can partly be implemented via an operating system, for use by a developer of services for a device or object, and/or included within application software that operates in connection with the component(s) of the innovation. Software may be described in the general context of computer executable instructions, such as program modules, being executed by one or more computers, such as client workstations, servers, or other devices. Those skilled in the art will appreciate that the innovation may be practiced with other computer system configurations and protocols.

FIG. 13 thus illustrates an example of a suitable computing system environment 1300a in which the innovation may be implemented, although as made clear above, the computing system environment 1300a is only one example of a suitable computing environment for a media device and is not intended to suggest any limitation as to the scope of use or functionality of the innovation. Neither should the computing environment 1300a be interpreted as having any dependency or requirement relating to any one or combination of components illustrated in the exemplary operating environment 1300a.

With reference to FIG. 13, an exemplary remote device for implementing the innovation includes a general purpose computing device in the form of a computer 1310a. Components of computer 1310a may include, but are not limited to, a processing unit 1320a, a system memory 1330a, and a system bus 1321a that couples various system components including the system memory to the processing unit 1320a. The system bus 1321a may be any of several types of bus structures including a memory bus or memory controller, a peripheral bus, and a local bus using any of a variety of bus architectures.

Computer 1310a typically includes a variety of computer readable media. Computer readable media can be any available media that can be accessed by computer 1310a. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules, or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1310a. Communication media typically embodies computer readable instructions, data structures, program modules, or other data in a modulated data signal such as a carrier wave or other transport mechanism and includes any information delivery media.

The system memory 1330a may include computer storage media in the form of volatile and/or nonvolatile memory such as read only memory (ROM) and/or random access memory (RAM). A basic input/output system (BIOS), containing the basic routines that help to transfer information between elements within computer 1310a, such as during start-up, may be stored in memory 1330a. Memory 1330a typically also contains data and/or program modules that are immediately accessible to and/or presently being operated on by processing unit 1320a. By way of example, and not limitation, memory 1330a may also include an operating system, application programs, other program modules, and program data.

The computer 1310a may also include other removable/non-removable, volatile/nonvolatile computer storage media. For example, computer 1310a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 1321a through a non-removable memory interface such as an interface, and a magnetic disk drive or optical disk drive is typically connected to the system bus 1321a by a removable memory interface, such as an interface.

A user may enter commands and information into the computer 1310a through input devices such as a keyboard and pointing device, commonly referred to as a mouse, trackball or touch pad. Other input devices may include a microphone, joystick, game pad, satellite dish, scanner, or the like. These and other input devices are often connected to the processing unit 1320a through user input 1340a and associated interface(s) that are coupled to the system bus 1321a, but may be connected by other interface and bus structures, such as a parallel port, game port or a universal serial bus (USB). A graphics subsystem may also be connected to the system bus 1321a. A monitor or other type of display device is also connected to the system bus 1321a via an interface, such as output interface 1350a, which may in turn communicate with video memory. In addition to a monitor, computers may also include other peripheral output devices such as speakers and a printer, which may be connected through output interface 1350a.

The computer 1310a may operate in a networked or distributed environment using logical connections to one or more other remote computers, such as remote computer 1370a, which may in turn have media capabilities different from device 1310a. The remote computer 1370a may be a personal computer, a server, a router, a network PC, a peer device or other common network node, or any other remote media consumption or transmission device, and may include any or all of the elements described above relative to the computer 1310a. The logical connections depicted in FIG. 13 include a network 1371a, such local area network (LAN) or a wide area network (WAN), but may also include other networks/buses. Such networking environments are commonplace in homes, offices, enterprise-wide computer networks, intranets, and the Internet.

When used in a LAN networking environment, the computer 1310a is connected to the LAN 1371a through a network interface or adapter. When used in a WAN networking environment, the computer 1310a typically includes a communications component, such as a modem, or other means for establishing communications over the WAN, such as the Internet. A communications component, such as a modem, which may be internal or external, may be connected to the system bus 1321a via the user input interface of input 1340a, or other appropriate mechanism. In a networked environment, program modules depicted relative to the computer 1310a, or portions thereof, may be stored in a remote memory storage device. It will be appreciated that the network connections shown and described are exemplary and other means of establishing a communications link between the computers may be used.

While the present innovation has been described in connection with the preferred embodiments of the various Figures, it is to be understood that other similar embodiments may be used or modifications and additions may be made to the described embodiment for performing the same function of the present innovation without deviating therefrom. For example, one skilled in the art will recognize that the present innovation as described in the present application may apply to any environment, whether wired or wireless, and may be applied to any number of such devices connected via a communications network and interacting across the network. Therefore, the present innovation should not be limited to any single embodiment, but rather should be construed in breadth and scope in accordance with the appended claims.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Various implementations of the innovation described herein may have aspects that are wholly in hardware, partly in hardware and partly in software, as well as in software. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present innovation, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the innovation. In the case of program code execution on programmable computers, the computing device generally includes a processor, a storage medium readable by the processor (including volatile and non-volatile memory and/or storage elements), at least one input device, and at least one output device.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The terms “article of manufacture”, “computer program product” or similar terms, where used herein, are intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components, e.g., according to a hierarchical arrangement. Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to the various flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

Herein described is a method for dividing an image frame into blocks, the method in one embodiment includes dividing the frame into a plurality of N×N block lists encoded diagonally with respect to a plurality of parallel processing channels. The method can include dividing the frame into a plurality of 4×4 block lists encoded diagonally with respect to a plurality of parallel processing channels. The method can also include dividing the frame into a plurality of 4×4 block lists encoded diagonally with respect to a plurality of parallel processing channels with a GPU. The method can also include dividing the frame into a plurality of N×N block lists encoded diagonally with respect to a plurality of parallel processing channels with a GPU.

The method can also include outputting data by embedding the data into a decimal place. The method can also include outputting a first set of data by: outputting data by embedding the data into a decimal place; and outputting data by embedding the data into an integer place. The method can also include outputting a first set of data by: outputting data by embedding the data into a decimal place by division; and outputting data by embedding the data into an integer place by multiplication. The method can also include outputting a second set of data by outputting the second set of data without performing multiplication. The method can also include outputting a first set of data by performing both division and multiplication on the first set of data. The method can also include outputting a second set of data subsequent to the first set by performing only division on the second set of data. The method can also include determining a size of a block list and deciding to use a CPU or a GPU to perform processing at least partially based on the determined size.

Also herein described is a video encoding apparatus for encoding video in a computing system, the apparatus including at least one data store for storing a plurality of frames of video data; an application component that requests encoding of the plurality of frames; and a processing component for processing the plurality of frames in response to the request, the processing component configured to determine a size of a block list and decide to use a CPU or a GPU at least partially based on the determined size. The apparatus can be configured such that the processing component further configured to divide a frame into a plurality of N×N block lists encoded diagonally with respect to a plurality of parallel processing channels. The apparatus can be configured such that the processing component is further configured to divide a frame into a plurality of N×N block lists encoded diagonally with respect to a plurality of parallel processing channels with a GPU. The apparatus can be configured such that the processing component configured to output a first set of data by: outputting data by embedding the data into a decimal place by division; and outputting data by embedding the data into an integer place by multiplication. The apparatus can be configured such that the processing component is configured to output a second set of data by outputting the second set of data without performing multiplication. The apparatus can be configured such that the processing component is further configured to divide a frame into a plurality of N×N block lists with a GPU. The apparatus can be configured such that the processing component is further configured to divide a frame into a plurality of N×N block lists encoded diagonally with respect to a plurality of parallel processing channels with a GPU.

A video encoding apparatus for encoding video in a computing system is also herein disclosed, the apparatus includes at least one data store for storing a plurality of frames of video data; an application component that requests encoding of the plurality of frames; and a processing component for processing the plurality of frames in response to the request, the processing component configured to divide a video frame into a plurality of N×N block lists with a GPU. The apparatus can be configured such that the processing component further configured to determine a size of a block list and decide at least partially based on the determined size whether to use a CPU or a GPU to perform processing.

Also herein disclosed is a video encoding apparatus for encoding video in a computing system, the apparatus includes at least one data store for storing a plurality of frames of video data; and a processing component for processing the plurality of frames in response to the request, the processing component configured to dividing with a GPU the frame into a plurality of N×N block lists encoded diagonally with respect to a plurality of parallel processing channels.

While the present innovation has been described in connection with the preferred embodiments of the various figures, it is to be understood that other similar embodiments may be used or modifications and additions may be made to the described embodiment for performing the same function of the present innovation without deviating therefrom.

While exemplary embodiments refer to utilizing the present innovation in the context of particular programming language constructs, specifications, or standards, the innovation is not so limited, but rather may be implemented in any language to perform the optimization algorithms and processes. Still further, the present innovation may be implemented in or across a plurality of processing chips or devices, and storage may similarly be effected across a plurality of devices. Therefore, the present innovation should not be limited to any single embodiment, but rather should be construed in breadth and scope in accordance with the appended claims.

What is claimed is:

1. A method for encoding video data, comprising:
receiving an original frame of data and a reconstructed frame of data by at least one central processing unit (CPU), the reconstructed frame of data representing a previous frame of data in a sequence of image frames represented by the video data;
determining block list data that determines an order of processing N×N blocks within at least one intra frame encoding process applying to the original frame and reconstructed frame by at least one co-processing unit; and
transmitting the original frame, the reconstructed frame and the block list data to at least one co-processing unit, whereby the at least one co-processing unit parallelizes the processing of the at least one intra frame encoding process based on at least the block list data.

2. The method of claim 1, further comprising:
performing by the at least one co-processing unit at least one of intra frame prediction, an integer cosine transformation, a quantization, a dequantization, an inverse integer cosine transformation or a reconstruction based on the original frame, the reconstructed frame or both.

3. The method of claim 2, further comprising:
determining a mode for encoding by the at least one processing unit.

4. The method of claim 2, further comprising:
determining a set of residual coefficients for encoding by the at least one processing unit.

5. The method of claim 2, further comprising:
determining a reconstructed block from the original frame by the at least one processing unit.

6. The method of claim 1, further comprising:
storing the original frame, the reconstructed frame and the block list data in texture memory of the at least one co-processing unit.

7. The method of claim 1, wherein the transmitting includes transmitting the original frame, the reconstructed frame and the block list data to at least one graphics processing unit (GPU).

8. A computer readable medium comprising computer executable instructions for performing the method of claim 1.

9. A method for dividing an image frame into blocks, comprising:
receiving a frame of a plurality of image frames; and
dividing the frame into a plurality of N×N block lists encoded diagonally with respect to a plurality of parallel processing channels for performing intra frame encoding on blocks of the frame.

10. The method of claim 9, further comprising:
performing parallelized intra frame encoding operations on blocks of the frame using the plurality of parallel processing channels based on at least one previous reconstructed frame and in an order specified by the plurality of N×N block lists.

11. The method of claim 9, wherein the dividing includes dividing the frame into a plurality of 4×4 block lists encoded diagonally with respect to a plurality of parallel processing channels.

12. The method of claim 9, wherein the dividing includes dividing the frame into a plurality of N×N block lists encoded diagonally with respect to a plurality of parallel processing channels of a graphics processing unit (GPU).

13. The method of claim 9, further including:
outputting a first set of encoded data by:
first embedding some of the encoded data into an integer place storage location; and
second embedding some of the encoded data into a decimal place storage location.

14. The method of claim 13, wherein the first or second embedding the encoded data includes at least one of multiplying the data or dividing the data by a value prior to the first or second embedding.

15. The method of claim 9, further including:
determining a size of a block list and for a threshold size or less, using a central processing unit (CPU) to perform intra frame encoding of the image frames and for greater than the threshold size, using a graphics processing unit (GPU) to perform intra frame encoding of the image frames.

16. The method of claim 9, wherein the dividing includes introducing an offset at each row of blocks, so that reconstructed block information can be re-used according to a parallelization process for intra frame encoding carried out via the plurality of parallel processing channels.

17. A video encoding apparatus for encoding video in a computing system, comprising:
at least one data store for storing a plurality of frames of video data; and
a processing component for performing intra frame encoding of the plurality of frames, the processing component configured to determine a size of a block list associated with the plurality of frames to be encoded indicating an order for processing and to perform the intra frame encoding with a central processing unit (CPU) or a graphics processing unit (GPU) based at least in part on the size of the block list.

18. The apparatus according to claim 17, wherein the block list determines an order of performing steps of the intra frame encoding on blocks of the frames of the plurality of frames.

19. The apparatus according to claim 17, wherein the processing component is further configured to divide a frame into a plurality of N×N block lists encoded diagonally with respect to a plurality of parallel processing channels.

20. A video encoding apparatus for encoding video in a computing system, comprising:
means for storing a plurality of frames of video data; and
means for encoding the plurality of frames with intra frame prediction information including means for dividing blocks of the frames into a plurality of ordered N×N block lists encoded diagonally for re-use of reconstructed frame data using parallel processing channels.
